(19) United States
(12) Patent Application Publication
(10) Pub. No.: US 2023/0017314 A1
(43) Pub. Date: Jan. 19, 2023

(54) SYSTEM AND METHOD FOR MANAGING AUTHENTICATION SERVICES

(71) Applicant: Swivel Secure Limited, Leeds (GB)

(72) Inventor: Alexandre Joao Loureiro Da Rocha, Coslada (ES)

(21) Appl. No.: 17/780,416

(22) PCT Filed: Nov. 25, 2020
(86) PCT No.: PCT/GB2020/052990

§ 371 Date: May 26, 2022

(30) Foreign Application Priority Data
Nov. 26, 2019 (GB) 1917185.9

(51) Int. Cl. G06F 21/12; H04L 9/40

(52) U.S. Cl. CPC G06F 21/123; H04L 63/0838; G06F 2221/2153

(57) ABSTRACT

There is disclosed a method of providing an authentication service, wherein: i) a plurality of authentication virtual appliances is deployed in a distributed network by way of an authentication management platform application; ii) a pool of authentication licences is allocated to the authentication management platform application, each licence comprising computer code permitting an end user to authenticate his/her identity to at least one authentication virtual appliance by way of a predetermined computer-implemented authentication protocol; and iii) the management platform application allocates, revoke and reallocate authentication licences, from the pool of authentication licences, to end users by way of a graphical user interface.

This invention relates to a system and method for managing authentication services, and in particular to techniques for centrally revoking and reallocating user licences in a managed services environment. In some embodiments, the invention provides a system and method for managing hardware tokens in a managed authentication services environment.

### BACKGROUND

In recent years, the concept of “on demand” distributed computing such as cloud computing and software as a service has become popular. In this model, rather than buying in expensive hardware such as dedicated servers, data storage and data processors, a customer instead rents computing power from a third party. The third party provider owns and is responsible for the maintenance of the hardware, and leases resources to the customer, typically in the form of virtual machines running in a distributed environment. It is possible for a provider to run many different virtual machines on the same hardware and sharing the same resources, while keeping the data being processed by different customers' virtual machines completely separated from other customers' data.

Businesses and organisations may contract their distributed computing requirements to a Managed Services Provider (MSP), who may then take responsibility for providing a secure and reliable service. Moreover, there are opportunities for Managed Security Services Providers (MSSPs) to whom various security and authentication responsibilities may be contracted directly by a business or organisation, or by way of subcontracting through an MSP.

A virtual machine is a software computer that, like a physical computer, runs an operating system and applications. A virtual machine typically comprises a set of specification and configuration files and is backed by the physical resources of a host. A virtual machine has virtual devices that provide the same functionality as physical hardware, and can provide additional benefits in terms of portability, manageability and security.

In such an environment, it is important to be able to offer authentication services so that users can access the virtual machines and relevant data in a secure manner. At a very basic level, authentication can be provided by way of a username and password protocol. Like many authentication protocols, this relies on a “shared secret” (the password) that is known both the user and to the system to which the user wishes to gain access. The weakness of this protocol is that users are often not sufficiently careful with their passwords, choosing easily-guessable words or phrases, or writing down their passwords on paper. It can also be relatively easy to intercept simple passwords by way of “man in the middle” techniques, where communications between a user and the system are intercepted, or by way of other techniques such as keystroke loggers or even something as simple as shoulder-surfing.

Accordingly, more sophisticated authentication protocols have been developed. These are known as two-factor authentication protocols, since an authentication factor in addition to username/password is required for successful authentication. Multi-factor authentication generalises this approach to more than two authentication factors. One such protocol involves the use of hardware or software tokens that are issued to users and which generate predetermined security codes that can supplement a user password. Such tokens provide an additional level of security by requiring a user to be in possession of both a password and an appropriate token. In some cases, the token may require input of a further password or passcode in order to generate a valid security code. This may take the form of a challenge-response authentication mechanism by way of an asynchronous token. Another protocol involves a message being sent to a user's mobile device when the user tries to authenticate himself using a username/password combination, the message containing a further security code that then needs to be entered to complete the authentication process. This provides an additional level of security by requiring a user to be in possession of both a password and a registered mobile device. In some cases, a user's mobile device may itself contain a token, and aspects of both systems can be combined. For example, a common two-factor authentication protocol known as Time-based One-Time Password (TOTP) works on the basis of a private key that is shared between a host system and a user's mobile device during initial set-up, for example by way of a QR code. One-time passwords (OTPs) can be generated by hashing the private key with the current time (this is known as a synchronous token mechanism) in both the user's mobile device and at the host—if the OTPs match, then the host can be assured that the user is in possession of the private key, which is a shared secret additional to the invariant user password. OTPs may take a relatively simple form—for example, a string of six digits. Even if an OTP is intercepted by way of a man-in-the-middle attack, the OTP cannot be used on a subsequent occasion because the time will be different on the subsequent occasion, which means that the hash of the private key with the current time will lead to a different OTP. Moreover, provided that a suitable one-way hash algorithm is used, it is not possible to determine the private key on the basis of an intercepted OTP and the current time. A variation of this protocol is HMAC-based One-Time Password (HOTP) which uses an incrementing counter value rather than time as the variable that is hashed with the private key to generate an OTP.

Other authentication protocols more sophisticated than a simple username and password combination are known, details of which will not be provided in the present application since they are part of the general competence of those skilled in the art.

However, any MSP or MSSP making use of authentication protocols more sophisticated than a simple username/password combination will generally need to license some kind of authentication service from a specialist authentication provider, and will often need to purchase associated tokens (either hardware or software) so that users can authenticate themselves using the desired authentication protocol. This can lead to problems when users are redeployed within an organisation, especially internationally, or where a client of an MSSP undergoes organisational changes. This is because user licences (and, in some cases, associated tokens) that are valid in one country might not be valid in another country. In addition, once a user licence has been assigned to a particular user, it is very difficult to re-assign that licence to another user, since permissions may need to be obtained from a number of intermediary organisations, including local licence distributors and/or resellers. In a typical MSP/MSSP environment, this means that it is easier for a service manager to assign a brand new licence each time a user moves within an organisation or when an existing user leaves an organisation and is replaced by a new user.

A hardware token is typically in the form of a simple electronic device incorporating a programmed chip. There are several different types of hardware token. Examples include: i) synchronous dynamic password tokens, where a timer is used to cycle through various combinations produced by a cryptographic algorithm, in which case the token and the authentication server must have synchronised clocks; ii) asynchronous password tokens, in which a one-time password is generated without the use of a clock, for example from a one-time pad (OTP) or a cryptographic algorithm; and iii) challenge-response tokens, which can make use of public key cryptography, the authentication server encrypting a challenge with a public key, and the token proving it is in possession of the matching private key by responding with the decrypted challenge. Hardware tokens may take the form of disconnected tokens, which do not have any connection to an external computer, but instead have a display configured to display a password or passcode for a user to enter into a client device as part of an authentication service. Other hardware tokens may take the form of a connected token, which is physically or logically connected to a computer in order to effect authentication. Examples include smartcards and USB tokens, or contactless tokens making use of NFC, RFID, Bluetooth or other wireless protocols.

All but the very simplest hardware tokens incorporate a seed and a unique identifier or registration number. The unique identifier or registration number is associated with a particular user when the hardware token is issued to that user. The seed is a number that is used to initialise a pseudorandom number generator. For a given pseudorandom number generating algorithm, identical seeds will generate identical sequences of pseudorandom numbers or codes. If the same random seed is deliberately shared, it becomes a secret key, so two or more systems using matching pseudorandom number algorithms and matching seeds can generate matching sequences of non-repeating numbers or codes.

There is a particular problem associated with the management of hardware tokens in authentication systems. Each hardware token is assigned a random seed at manufacture, and this seed is securely encoded in a memory of the hardware token. However, in order for the hardware token to be useful, it is necessary for an authentication service also to know the seed assigned to each token. This is because the authentication server needs to run the same cryptographic algorithm as the hardware token and verify that a particular hardware token is generating the expected pseudorandom number or code on the basis of the seed. While the random seeds can be securely “baked in” to the hardware tokens during manufacture, it is necessary to share the seeds with an operator of an authentication server in order to the hardware tokens to be usefully deployed. The operator of the authentication server must associate the respective seeds with the respective unique identifiers or registration numbers of the hardware tags on the authentication server, and this represents a weak link. If a third party were to come into possession of the seeds, whether by hacking an authentication server or through an unscrupulous or criminal employee of the authentication server operator, it would be possible to duplicate the cryptographic algorithm used to generate the pseudorandom numbers or codes, thus rendering the hardware token insecure.

Furthermore, if an MSP or MSSP offers a hardware token based authentication service to its customers, it is necessary for the MSP or MSSP to share the seeds with its customers so that the customers can make full use of the hardware tokens within their organisations. Although it may be desirable to reassign hardware tokens from a first customer to a second customer, for example at the end of a contract, the second customer has no guarantee that the first customer has maintained the security of the seeds. This is why hardware tokens are generally sold as being personal and non-transmissible to new customers. As a result, an MSP or MSSP needs to issue brand new hardware tokens to each new customer in order to guarantee security, with the old tokens having to be scrapped.

### BRIEF SUMMARY OF THE DISCLOSURE

Viewed from a first aspect, there is provided a method of managing hardware tokens in an authentication service, wherein:

at least one hardware token comprising a securely stored seed and a token identifier is provided by a service provider;

the service provider associates the seed of the hardware token with the token identifier of the hardware token on a secure server operated by the service provider;

the service provider makes the hardware token and the token identifier available to a customer; and

the customer assigns the hardware token to an end user and operates an authentication server in which the token identifier is associated with the identity of the end user to whom the hardware token is assigned;

wherein the seed of the hardware token is securely made available to the customer's authentication server by the service provider's server for association with the token identifier without being accessible by the customer or the end user; and

wherein the authentication server authenticates the identity of the end user to the customer by way of a cryptographic challenge based on the seed of the hardware token.

Viewed from a second aspect, there is provided a system for managing hardware tokens in an authentication service, the system comprising:

at least one hardware token comprising a securely stored seed and a token identifier;

a secure server operating by a service provider; and

an authentication server operated by a customer;

wherein the secure server is configured to associate the seed of the hardware token with the token identifier of the hardware token;

wherein the authentication server is configured to associate the token identifier with an identity of an end user to whom the hardware token is assigned;

wherein the authentication server is configured to receive the seed of the hardware token securely from the secure server and to associate the seed with the token identifier on the authentication server without the seed being accessible to the customer or the end user; and

wherein the authentication server is configured to authenticate the identity of the end user to the customer by way of a cryptographic challenge based on the seed of the hardware token.

Viewed from a third aspect, there is provided an authentication server of a system for managing hardware tokens in an authentication service, wherein:

the authentication server is operated by a customer of a service provider;

the authentication server is configured to associate a token identifier of a hardware token with an identify of an end user to whom the hardware token is assigned;

the authentication server is configured to receive a seed of the hardware token from a secure server operated by the service provider and to associate the seed of the hardware token with the token identifier of the hardware token without permitting access to the seed by the customer or the end user; and

the authentication server is configured to authenticate the identity of the end user to the customer by way of a cryptographic challenge based on the seed of the hardware token.

Viewed from a fourth aspect, there is provided a method of providing an authentication service, wherein:

i) a plurality of authentication virtual appliances is deployed in a distributed network by way of an authentication management platform application;

ii) a pool of authentication licences is allocated to the authentication management platform application, each licence comprising computer code permitting an end user to authenticate his/her identity to at least one authentication virtual appliance by way of a predetermined computer-implemented authentication protocol; and

iii) the management platform application allocates, revoke and reallocate authentication licences, from the pool of authentication licences, to end users by way of a graphical user interface.

Viewed from a fifth aspect, there is provided a computer-implemented authentication management platform application configured for implementation in a distributed network in which is deployed a plurality of authentication virtual appliances, wherein a pool of authentication licences is allocated to the authentication management platform application, each licence comprising computer code permitting an end user to authenticate his/her identity to at least one authentication virtual appliance by way of a predetermined computer-implemented authentication protocol; and wherein the management platform application is configured to allocate, revoke and reallocate authentication licences, from the pool of authentication licences, to end users by way of a graphical user interface.

The various aspects may be implemented individually or in appropriate combinations with each other.

Embodiments of the present disclosure are configured to provide MSPs and MSSPs with specialised authentication capabilities to deliver to their customers as their own offering. This could be as a standalone service or in combination with other services offered by the MSP/MSSP.

Hardware tokens suitable for use with the present disclosure may be OATH® protocol compliant. OATH® is an open-source system architecture for authentication. Hardware tokens making use of other authentication protocols may also be used, provided that the hardware tokens make use of seeds in order to generate pseudorandom number sequences that can be replicated on an authentication server with access to the same seeds and other relevant parameters.

Hardware tokens suitable for use with the present disclosure may use one of two main protocols. The first is Time-based One-time Password (TOTP), and the second is Hash-based message authentication code One-time Password (HOTP).

In TOTP, each token has a token identifier (e.g. a serial number) and a seed. The seed is typically in the form of a number. Each token also includes an embedded clock or timer. The clock or timer may be configured to count Epoch or Unix® time, which is the number of seconds that have elapsed since GMT/UTC midnight on 1 Jan. 1970, not counting leap seconds. However, other time measurement protocols may be used, provided that the hardware token and the authentication server both use the same protocol. Each token also implements a predetermined timeframe, which is often set to 30 s or 60 s. Again, the precise timeframe is not important, so long as it is shared with the authentication server. When a hardware token is activated by an end user, for example by pressing a button, a processor inside the token divides the Epoch or Unix® time into the timeframe interval and determines an authentication time. A cryptographic algorithm running on the processor takes the authentication time and the seed as inputs, and generates a pseudorandom number. The same cryptographic algorithm is run on the authentication server in order to authenticate the token. It will be understood that the authentication server needs to know the token identifier and the seed of a given token, as well as the authentication time based on the relevant time measurement protocol and the timeframe used by the token. If the authentication server, running the same cryptographic algorithm as the token, is able to reproduce the same pseudorandom number on the basis of the same inputs used by the processor of the token, the identity of the token bearer is authenticated. The authentication server may recalculate the timeframe plus and minus 5 to 10 seconds, for example, in order to compensate for time delays and time synchronisation issues.

In HOTP, each token has a token identifier (e.g. a serial number) and a seed. The seed is typically in the form of a number. Each token also includes an embedded counter configured to increment a count each time the token is activated, for example by way of an end user pressing a button. The count may be used as an input for a hash algorithm, for example an MD5 or SHA hash algorithm. An HOTP token does not require a timeframe or clock. Whenever the end user activates the token, the count is incremented, and the count value is used to hash the next MD5 or SHA (for example) digestion. A cryptographic algorithm can take the hash data and the seed and use these to generate a pseudorandom number. The same cryptographic algorithm is run on the authentication server in order to authenticate the token. It will be understood that the authentication server needs to know the token identifier and the seed of a given token, as well as the count value (token sync). If the authentication server, running the same cryptographic algorithm as the token, is able to reproduce the same pseudorandom number on the basis of the same inputs used by the processor of the token, the identity of the token bearer is authenticated. Typically, the authentication server may hash −5 to +5 count values from the registered last count value and may generate an array of acceptable pseudorandom numbers against which the pseudorandom number generated by the token may be matched. This can help to compensate for accidental counter increments (due to accidental button presses) or broken communications links on previous authentications.

In each of TOTP and HOTP, it is necessary for the authentication server to “know” the seed of each individual hardware token, with the seeds being stored in association with the token identifiers and the end user identities. However, in existing systems and methods, this requires the seeds to be made available to customers operating the authentication server. The seeds on the hardware tokens can be securely coded or “baked in” at manufacture, but the corresponding seeds on the authentication server are typically added manually by an operator. This represents a weak link, since the seeds must travel from the token manufacturer to the MSP/MSSP (the service provider) to the customer (the operator of the authentication server), and this can involve the seeds being handled in plaintext form by a human operator, who could be unscrupulous. If the seeds become known to a third party, then that third party could crack the authentication algorithm and/or replicate a hardware token using the same cryptographic algorithm, thus rendering the original hardware token insecure.

It is for this reason that hardware tokens are generally treated as non-transferrable. Because a human actor has to add the token identifiers and seeds to the authentication server, there is no guarantee for a subsequent customer that the token identifiers and seeds of previously-used tokens have not been used to generate cloned hardware tokens.

In the context of the present disclosure, a “service provider” may be an MSP or MSSP, a “customer” may be an organisation or business that rents or buys computer services from the service provider, including authentication services, and an “end user” is an individual person such as an employee of the customer, or a person using the customer's services, such as an account holder where the customer is a financial institution, e.g. a bank.

Embodiments of the present disclosure are designed to eliminate the human actor on the customer side. For example, a customer may rent or buy a predetermined number of hardware tokens from the service provider, and rent authentication services from the service provider. The authentication server operated by the customer in order to authenticate end users to the customer is configured to receive the seeds of the hardware tokens securely from the secure server operated by the service provider without making the seeds available to the customer or the end users. In other words, the seeds of the hardware tokens can be injected into the customer's authentication server without having to be entered manually by a human operator, and without being visible to anyone within the customer organisation. This means that the only actor with access to the seeds is the service provider, not the customer. As a result, at the end of a service contract, the customer can return the hardware tokens to the service provider, and the hardware tokens can be re-used by the service provider for a new customer. The new customer will have a guarantee that the hardware tokens remain secure, since the previous customer will not have had access to the seeds. In this way, hardware tokens can be re-used many times, optionally with refurbishment. This provides cost savings for all parties, and also reduces environmental damage that might otherwise be caused by scrapping otherwise operational hardware tokens simply because their security cannot be guaranteed.

It is possible to add an extra layer of security at the service provider by way of function segregation, with the addition of new hardware tokens to the secure server (where hardware token seeds must be entered on the secure server) being undertaken independently of token assignation/re-assignation (to particular customers). In this way, there is no link between any actor who knows the seeds of particular tokens and the customer who is actually assigned the tokens.

In one embodiment, there is provided a software-based command and control appliance, for example an instance of a virtual machine, configured to deliver the authentication service. The appliance can be made available with licences and, where required, tokens (software and/or hardware) so as to enable different users to be set up on the system. The licences can be collated in a licence pool controlled by the command and control appliance.

An important feature of embodiments of the present disclosure is that allocation and use of purchased licences is wholly within the control of the MSP/MSSP, provided that the MSP/MSSP remains within the bounds of any overall service licence that may have been agreed with the authentication service provider. The command and control appliance may be configured to communicate with a licensing server operated by the authentication service provider so as to allow management of purchased licences by the MSP/MSSP.

The authentication management platform application is configured to deploy at least two authentication virtual appliances in a distributed network. This may be done, for example, within a VMWare environment controlled and orchestrated by a VMWare Vcentre Server, although it will be understood that other virtualisation protocols may be used. The at least two authentication virtual appliances can be stand-alone virtual appliances or may be combined as an HA (High Availability) pair or cluster. Individual licences are not required, since licences will be allocated through the authentication management platform application from the pool of authentication licences.

The graphical user interface of the authentication management platform application enables centralised management of the majority of appliance instance functions (this support can increase per release). However, it is also possible for the MSP provider to connect directly to each instance and control local core functions. Based on further API usage on the MSP provider's end, it can even create a manager application to allow the final user-customer some “space” to play around the core assigned to them. In some implementations, a base of customers may be provided with an installation of the core appliance complemented by a customized application to manage users, totally integrated within the user lifecycle management rules.

The authentication management platform application may be configured to control the deployment, monitoring, access, management, licensing and logging of multiple authentication virtual appliances.

The authentication management platform application may provide a secure, robust and modular platform. In some embodiments, it may be based on VMWare Virtual Appliance protocols, but in other embodiments may be virtualisation agnostic.

In some embodiments, the authentication management platform application may be accessed through a Web browser. The authentication management platform application provides a graphical user interface to allow authentication management by an authorised manager. The graphical user interface may be customised and/or branded as required by different MSPs.

The authentication management platform application may be used to deploy and configure authentication virtual appliances. The authentication management platform application may be used to provide monitoring capabilities for the deployed/managed authentication virtual appliances.

The authentication management platform application may be configured to manage a pool of licences and tokens that can be allocated, revoked and reallocated to different authentication virtual appliances and/or end users.

The authentication management platform application may be configured to provide centralised logging capabilities for managed authentication virtual appliances.

The authentication management platform application may be configured to provide centralised email or other alerting capability, and to provide centralised reporting capability.

The authentication management platform application may be configured to communicate by way of an appropriate Application Program Interface (API) and/or Secure Shell (SSH) with the authentication virtual appliances (e.g. in a VMWare environment), and also with a licensing server providing the pool of authentication licenses.

The authentication management platform application may be configured to provide software management for managed authentication virtual appliances.

The authentication management platform application may be configured to manage and distribute OATH (Initiative for Open Authentication) tokens across managed authentication virtual appliances.

The authentication management platform application may be configured to provide an Instance Manager to manage authentication virtual appliance instances, for example to create, edit and/or exclude instances. For example, in a specific instance, there may be provided the capability of shutting down, booting up, rebooting or modifying the configuration. Individual instance service checking allows the status of a service to be checked, as well as providing the ability to start, stop and restart services. The Instance Manager may be configured to allow software installed on the authentication virtual machines to updated under central control.

The authentication management platform application may incorporate a Licence Manager to allow simple and versatile management of a pool of authentication licences. The licences can be allocated across managed authentication virtual machine instances. Licenses can be allocated, revoked and reallocated as needed.

The Licence Manager may be configured to recognise different types of authentication product licence. Out of those, an MSP product licence may instruct the Licence Manager to allow the creation of a sub-set of licences that will enable a customer to re-license from his/her allocated pool of licences on demand.

An authentication service MSP core may be configured to connect to the Licence Manager and to present itself as an MSP-type of “pool” licence. It can then request the creation of subsets of licences. The server may calculate the total number of allocated licences from this main pool and verify that no violation can happen (for example, requesting more licences than are available), and if clear, may generate and deliver a new licence sub-set to a new requested core.

In some embodiments, it is possible also to divide the licence server type of licence in terms of features. For example, certain authentication protocols may be enabled or disabled via licence, providing another granularity feature that can help an MSP better direct the product line offer to customer needs.

Sub-licensing may take place within the authentication management platform application (e.g. MSP product dashboard management), which means that it is possible to collect usage data from the distributed appliances base and make management decisions and adjustments to licences. For example, if client X is using 50% of its installed licences while customer Y is reaching a 90% usage threshold, the authentication management platform application may allow new licences to be allocated to client X from the supply of licences initially allocated to client Y so as to provide better asset usage.

In some embodiments, the authentication management platform application may incorporate a Token Manager to provide flexible management of a pool of tokens. The Token Manager allows tokens to be distributed by instances, or to be imported directly, or simply to add or remove tokens. The Token Manager may be configured to manage software tokens and/or hardware tokens. For example, tokens can be moved between cores, and available tokens can be assigned to users. As software tokens have a non-firmware seed, they hold a one-to-one relationship with the core. This means that the assignment is automatic and supported by a re-provisioning process that also regenerates the seed. This has advantages over hardware tokens, where an old seed is necessarily transferred to a new owner of the hardware token.

The authentication management platform application may be configured to provide centralized log data collection to allow easier troubleshooting across individual or all instances being managed.

Visibility and management of the instances and/or authentication virtual appliances is undertaken through the graphical user interface. There may be provided a primary dashboard, presenting easily digestible information regarding the status of instances, licence distribution, active users, number of authentications and attempts.

The reporting capability provides the ability to generate reports both manually and scheduled (delivered via email) and allows exporting the data into CSV or Excel. This data can then be shared with other systems and can feed into MSP/MSSP billing systems.

The graphical user interface can be customised in terms of colour palette and can have MSP/MSSP logos uploaded to support desired branding.

Embodiments of the present disclosure may be based on the premise that the customer can instance as many machines as he/she needs. As such, the licence server controls the licence pool and no further control in needed, apart from the EULA. If, however, the IP (Internet Protocol) address changes, and the authentication management platform application is offline from the licence server and an offline license request happens, this may indicate unauthorised cloning of one or more virtual appliances. Accordingly, should this be detected, then authentication management platform application may issue an immediate lockdown to all virtual appliances under its management.

### BRIEF DESCRIPTION OF THE DRAWINGS

Embodiments of the invention are further described hereinafter with reference to the accompanying drawings, in which:

FIG. 1 is a schematic illustration of a high level architecture of an embodiment of the disclosure;

FIG. 2 is a schematic illustration of an MSP services layer of an embodiment of the disclosure; and

FIG. 3 is a schematic illustration of a secure server, authentication server and hardware token system of an embodiment of the disclosure.

### DETAILED DESCRIPTION

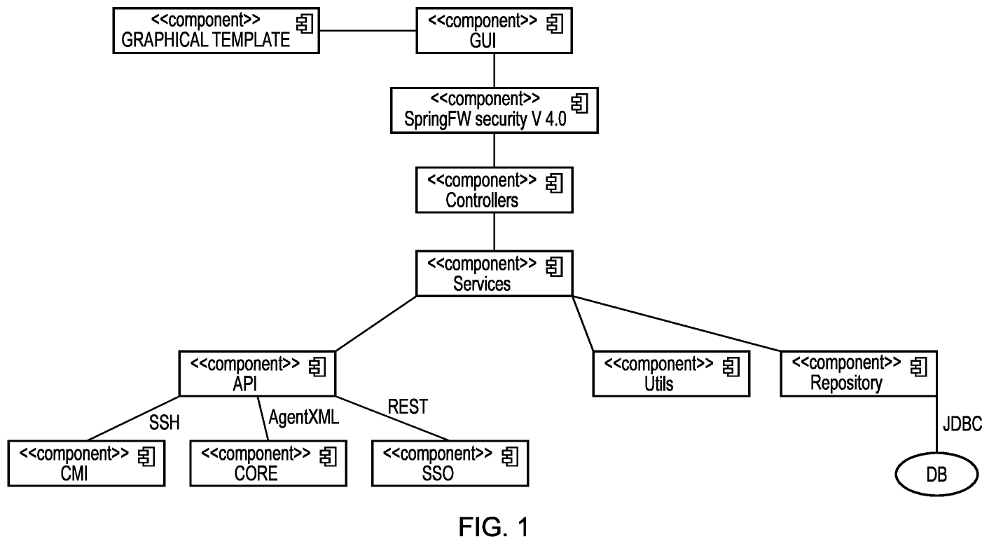

FIG. 1 shows a high level architecture of an embodiment of the disclosure. A GUI element 1, which is responsible for interaction with a user interface, grabs display patterns from graphical templates 2 and passes user actions to a second layer 3.

The second layer 3 may, for example, be implemented an industry-standard authentication and access-control framework for secure I/O scrutiny, such as provided by Spring Security from Pivotal Software, Inc.

If the requests are passed as “clear” by the framework security scrutiny in the second layer 3, they are passed to a controller layer 4. The controller layer 4 is responsible for controlling business logic values and IAM (Identity and Access Management) validation. The prime function is to verify who is changing what, where any changes are being made, and if the changes are acceptable.

Once a request has cleared the controller layer 4, the request passes to a services layer 5, which may implement real “business logic” or “use case logic”.

The services layer 5 can delegate data persistency on a repository layer 6 and on an API (Application Program Interface) layer 7. The API layer 7 may provide an interaction dashboard to allow different APIs to be called as required, such as CMI (Content Management Interface) layer 8, an ASP.NET Core layer 9, and an SSO (Single Sign-On) layer 10. The repository layer 6 has access to a database 11, for example by way of JDBC (Java Database Connectivity).

The services layer 5 also has access to a utility layer 12 comprising appropriate reusable software tools.

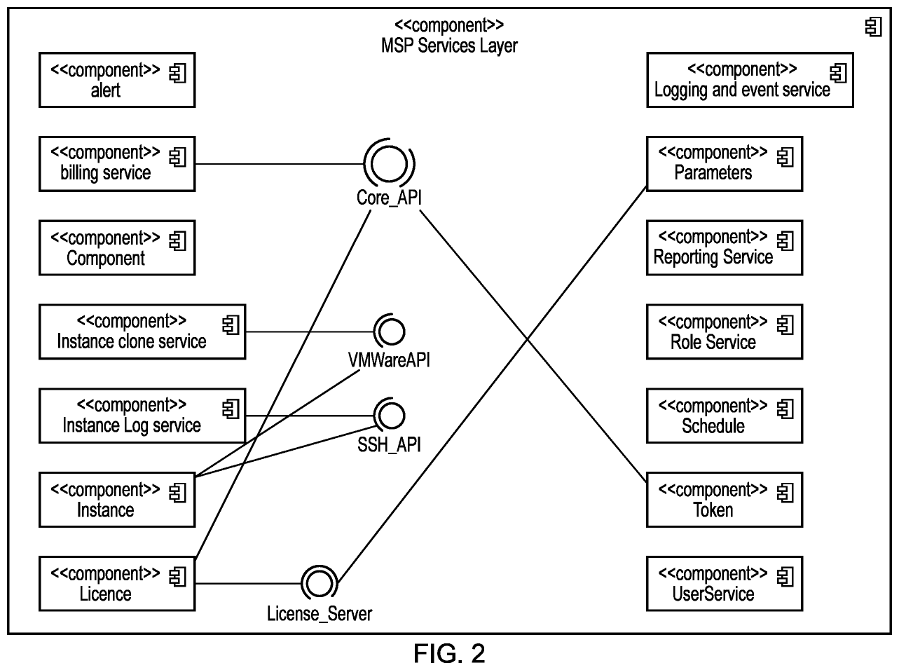

FIG. 2 shows an MSP (Managed Service Provider) services layer of an embodiment of the disclosure. The MSP services layer may comprise: i) Alert 13 (responsible for sending email alerts); ii) Billing service 14 (collects data form each appliance under management for billing purposes); iii) Component 15 (responsible for collecting and preparing dashboard data); iv) Instance clone service 16 (handles VCenter API link and commands); v) Instance log service 17 (gets and processes appliance logs); vi) Instance server 18 (provides in-instance management of services and configurations); vii) Licence service 19 (responsible for communicating with a licence server and updating running machines/appliances on the fly); viii) Logging and event service 20 (manages the logging events from an ESXi appliance); ix) Parameters service 21 (responsible for managing the requests and respective configuration parameters); x) Reporting service 22 (manages and aggregates reports); xi) Roles service 23 (IAM supporting local “by role” authorisation); xii) Scheduler service 24 (reports events and time slot management service); xiii) Token manager 25 (manages, synchronises, assigns and reassigns physical tokens); xiv) User service 26 (user management tools and functions).

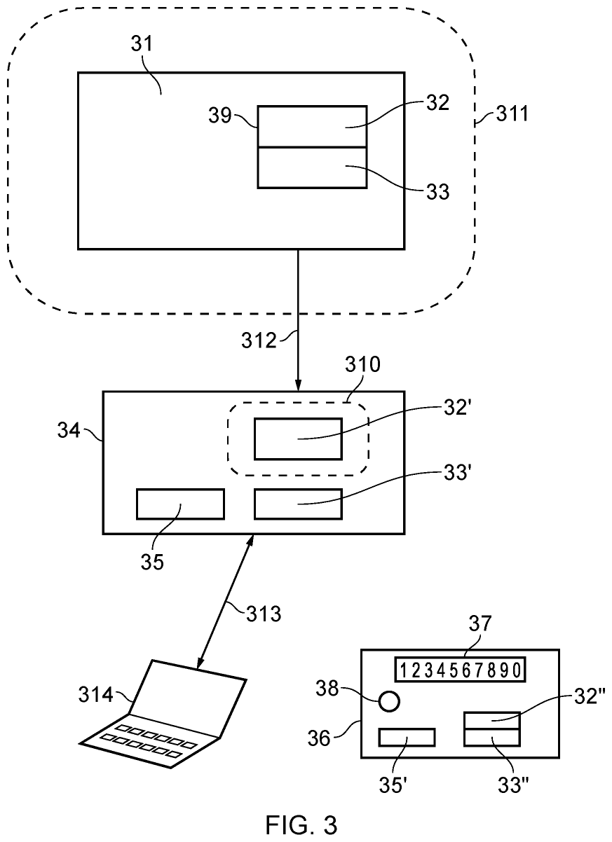

FIG. 3 is a schematic illustration of an embodiment comprising a secure server 31 operated by a service provider, such as an MSP or MSSP, an authentication server 34 operated by a customer, such as a bank, and a hardware token 36 operated by an end user, such as an account holder with the bank.

The secure server 31 is secured behind a firewall 311 or other security measures, and includes a database 39 in which a plurality of hardware token seeds 32 is associated with a corresponding plurality of hardware token identifiers 33 in one-to-one relation. The database 39 may be subdivided into separate databases for different customers.

The authentication server 34 is operated by the customer, and receives the seeds and the token identifiers securely from the secure server 31 by way of a secure link 312. The seeds 32′ received from the secure server 31 are held in a secure partition 310 of the authentication server 34 and are not accessible by the customer. The token identifiers 33′ received from the secure server 31 are accessible by the customer so as to allow the customer to assign tokens 36 to individual end users. Although the seeds 32′ are not accessible by the customer, they are stored in one-to-one relation with the token identifiers 33′. The authentication server 34 includes a processor 35 running a predetermined cryptographic algorithm configured to generate pseudorandom numbers on the basis of the seeds 32′ and other parameters as appropriate.

The hardware token 36 (in practice, there will be a plurality of hardware tokens 36 issued to a corresponding plurality of end users) is a small electronic device programmed on manufacture with a seed 32″ and a token identifier 33″, which may conveniently be stored in ROM. The hardware token 36 further comprises a processor 35′ running the same cryptographic algorithm as the processor 35 of the authentication server 34. The hardware token 36 includes an activation button 38 that, when pressed, causes the processor 35′ to generate a pseudorandom number by way of the cryptographic algorithm on the basis of the seed 32″ and to display the pseudorandom number on a display 37.

In order for an end user to authenticate himself/herself to the customer, a typical two-factor authentication process may be employed. The end user operates a client device 314 (for example, a PC or tablet or mobile handset) that communicates with the authentication server 34 by way of a link 313, which may be by way of the Internet. For example, the end user may navigate to a secure log in page on the Web, where the end user enters a user ID and (optionally) a password. This represents a first factor of a two-factor authentication process, and lets the authentication server know that a particular end user wishes to gain access. The authentication server 34 then requests the end user to generate a pseudorandom number using the hardware token 37 as previously described and to enter the pseudorandom number on the client device 314. The pseudorandom number entered by the end user is then transmitted to the authentication server 34. The authentication server 34 already knows the token identifier 33′ of the hardware token 36 that has been assigned to the authorised end user, and hence knows the seed 32′ of the hardware token 36. Accordingly, the processor 35 of the authentication server 34 can run the same cryptographic algorithm as that run by the processor 35′ of the hardware token 36, using the same seed 32′ and other relevant parameters (such as time or count), to generate a pseudorandom number (or selection of pseudorandom numbers). If there is a match between the pseudorandom number generated by the hardware token 36 and entered by the end user on the client device 314 and the pseudorandom number(s) generated by the authentication server 34, the identity of the end user is verified. This is the second factor in the two-factor authentication process.

The hardware token 36 can take forms other than that shown in the specific example of FIG. 3. For example, the hardware token 36 may be implemented as a USB or Bluetooth® dongle and be configured to provide the pseudorandom number directly to the client device 314 without the need to the end user to type in the pseudorandom number. In these embodiments, there is no need for the hardware token 36 to be provided with a display. Other variations will be apparent.

The processor 35′ of the hardware token 36 and the processor 35 of the authentication server 34 may use TOTP or HOTP or other seed-based protocols.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of managing hardware tokens in an authentication service, wherein: at least one hardware token comprising a securely stored seed and a token identifier is provided by a service provider;
the service provider associates the seed of the hardware token with the token identifier of the hardware token on a secure server operated by the service provider;
the service provider makes the hardware token and the token identifier available to a customer; and
the customer assigns the hardware token to an end user and operates an authentication server in which the token identifier is associated with the identity of the end user to whom the hardware token is assigned;
wherein the seed of the hardware token is securely made available to the customer's authentication server by the service provider's server for association with the token identifier without being accessible by the customer or the end user; and
wherein the authentication server authenticates the identity of the end user to the customer by way of a cryptographic challenge based on the seed of the hardware token.

2. A method according to claim 1, wherein the seed of the hardware token is stored on a secure partition on the authentication server that is not accessible by the customer.

3. A method according to claim 1, wherein the cryptographic challenge is a time-based one-time password, TOTP, challenge.

4. A method according to claim 1, wherein the cryptographic challenge is a hash-based message authentication code one-time password, HOTP, challenge.

5. A system for managing hardware tokens in an authentication service, the system comprising:
at least one hardware token comprising a securely stored seed and a token identifier;
a secure server operating by a service provider; and
an authentication server operated by a customer;
wherein the secure server is configured to associate the seed of the hardware token with the token identifier of the hardware token;
wherein the authentication server is configured to associate the token identifier with an identity of an end user to whom the hardware token is assigned;
wherein the authentication server is configured to receive the seed of the hardware token securely from the secure server and to associate the seed with the token identifier on the authentication server without the seed being accessible to the customer or the end user; and
wherein the authentication server is configured to authenticate the identity of the end user to the customer by way of a cryptographic challenge based on the seed of the hardware token.

6. A system as claimed in claim 5, wherein the authentication server is configured to store the seed of the hardware token on a secure partition that is not accessible by the customer.

7. A system as claimed in claim 5 or 6, wherein the cryptographic challenge is a time-based one-time password, TOTP, challenge.

8. A system as claimed in claim 5 or 6, wherein the cryptographic challenge is a hash-based message authentication code one-time password, HOTP, challenge.

9. An authentication server of a system for managing hardware tokens in an authentication service, wherein:
the authentication server is operated by a customer of a service provider;
the authentication server is configured to associate a token identifier of a hardware token with an identify of an end user to whom the hardware token is assigned;
the authentication server is configured to receive a seed of the hardware token from a secure server operated by the service provider and to associate the seed of the hardware token with the token identifier of the hardware token without permitting access to the seed by the customer or the end user; and
the authentication server is configured to authenticate the identity of the end user to the customer by way of a cryptographic challenge based on the seed of the hardware token.

10. An authentication server as claimed in claim 9, wherein the authentication server is configured to store the seed of the hardware token on a secure partition that is not accessible by the customer.

11. An authentication server as claimed in claim 9, wherein the cryptographic challenge is a time-based one-time password, TOTP, challenge.

12. An authentication server as claimed in claim 9, wherein the cryptographic challenge is a hash-based message authentication code one-time password, HOTP, challenge.

13. A method of providing an authentication service, wherein:
i) a plurality of authentication virtual appliances is deployed in a distributed network by way of an authentication management platform application;
ii) a pool of authentication licences is allocated to the authentication management platform application, each licence comprising computer code permitting an end user to authenticate his/her identity to at least one authentication virtual appliance by way of a predetermined computer-implemented authentication protocol; and
iii) the management platform application allocates, revoke and reallocate authentication licences, from the pool of authentication licences, to end users by way of a graphical user interface.

14. A computer-implemented authentication management platform application configured for implementation in a distributed network in which is deployed a plurality of authentication virtual appliances, wherein a pool of authentication licences is allocated to the authentication management platform application, each licence comprising computer code permitting an end user to authenticate his/her identity to at least one authentication virtual appliance by way of a predetermined computer-implemented authentication protocol; and wherein the management platform application is configured to allocate, revoke and reallocate authentication licences, from the pool of authentication licences, to end users by way of a graphical user interface.
